(19) United States
(12) Patent Application Publication
(10) Pub. No.: US 2026/0063865 A1
(43) Pub. Date: Mar. 5, 2026

(54) CYLINDRICAL MOUNTING FOR ADJUSTABLE OPTICAL AND MECHANICAL COMPONENTS

(71) Applicant: LEICA CAMERA AG, Wetzlar (DE)

(72) Inventor: Andreas Schwarz, Reiskirchen (DE)

(21) Appl. No.: 18/858,724

(22) PCT Filed: Apr. 21, 2023
(86) PCT No.: PCT/DE2023/100292

§ 371 Date: May 27, 2025

(30) Foreign Application Priority Data
Apr. 22, 2022 (DE) 10 2022 109 820.6

(51) Int. Cl. G02B 7/04; G02B 7/02; G03B 13/32; G03B 17/56

(52) U.S. Cl. CPC G02B 7/04; G02B 7/021; G02B 7/022; G02B 7/023; G03B 13/32; G03B 17/565; G03B 17/566

(57) ABSTRACT

The invention describes a cylindrical mounting (1) for adjustable optical and mechanical components, comprising a sleeve (2) which is stationary relative to a mounting; three sliding transmission elements distributed on the sleeve inner cylinder circumference for operative connection to corresponding grooves of a cam carrier (5) which is supported in the sleeve (2) in an rotationally and axially movable manner and which has a slot-shaped linear guide mechanism (6); and a rotary ring (7) which is stationary in axial direction, is supported on the outer surface of the sleeve and can be actuated from outside, which rotary ring has at least one transmission guiding element (8) for engagement in the slot-shaped linear guide mechanism (6) of the curved carrier (5), whereby the angle (W1-2) between the radius of a first (G1) and a second (G2) of the three sliding transmission elements (G1, G2, G3) is smaller than their respective angles (W1-3, W2-3) with respect to the third sliding transmission element (G3).

The invention relates to a cylindrical mounting for optical and mechanical components according to the precharacterizing part of claim 1, in particular a lens mounting for lenses for viewfinder cameras that can be adjusted to different object distances, with a distance setting ring and a device coupled thereto for transmitting the set distance to the setting lever of a movable optical element of a split-image rangefinder arranged on the camera side. Split-image rangefinders are also known as ++, coincidence finders or, colloquially, rangefinders. Rangefinder cameras are e.g., cameras of the applicant's M-system that have been known for decades for their compatibility with associated lenses of various focal lengths of the M-system.

In such photographic lenses, it is known to move one or more of the imaging lenses along the optical axis in order to image the object to be recorded sharply in the image recording plane of the camera; and it is also known to couple the movable optical element built into the rangefinder of the camera with the movable objective lens or the focus shifting mechanism of the lens via the setting lever in the camera. The shifting mechanism in the lens is usually a worm thread sleeve with or without a linear guide mechanism that can be operated from the outside by means of a distance setting ring having an internal thread.

With lenses having commonly used focal length, such as a 50 mm lens for the 35 mm format, a rotation of the distance setting ring with a rotation angle limited to less than 95° causes an axial shift of the worm thread sleeve for focusing and also a rotation of the latter around the system's optical axis. By resting the setting lever on the front side of the worm threat sleeve, it is coupled to the focus shifting mechanism of the lens. In this way, visual focus adjustment over a distance range of 0.7 m to infinity with a coupled movement of the setting lever by 4.5 mm is possible. Different, distance-dependent adjustment paths and possible non-linearities between the axial adjustment movement of the optical imaging system, which are required for focusing, and the coupled movement of the setting lever for the rangefinder are compensated for, e.g. by a pitch subsequently applied by milling on the front surface of the worm thread sleeve as a possibly linear or non-linear axial curve. The required mechanical effort for this is very high and, in addition, a great deal of work is required to apply the milling.

Depending on the lens design and focal length of the lens, the adjustment ranges of the focus shifting mechanism of the optics or the optics assembly required for focusing on object distances from infinity to a close range often differ considerably, while the adjustment range in the rangefinder is mechanically limited (“calibrated”) to correlate to object distances from 0.7 m to infinity due to the design, since the available adjustment range of the adjusting lever is always 4.5 mm.

The compatibility of the lenses with the camera with regard to the distance setting is achieved by converting the adjustment path of the setting lever in the rangefinder for the distance range from 0.7 m to infinity to the adjustment path predetermined by the camera, regardless of the various adjustment paths of the focusing mechanism.

This conversion must be conducted with high precision and therefore requires a high level of additional mechanical effort. Implementations based on the functional type of reduction gearing or transmission gearing with multiple nested worm threads and threaded sleeves are common.

A complex lens mounting of this type is known from DE 2 040 227 A1. The lens mounting contains several imaging lenses that can be shifted along the optical axis of the system via a distance setting ring to sharply image an object to be recorded in the imaging plane where the image is recorded. For this purpose, the distance setting ring is connected to an external threaded tube, designed as a threaded worm, which functions as a driving device. An inner threaded tube, also designed as a worm, is inserted into this threaded tube, and is guided in a straight-line inside the lens mounting, so that the rotation of the outer threaded tube is converted into a movement of the inner threaded tube along the optical axis of the system. The imaging lenses are fixed in place in the inner threaded tube and therefore participate in this axial longitudinal movement. A cam ring is also rotatably inserted into the inner threaded tube on the camera side, which is driven by a driving pin connected to the outer threaded tube. The cam ring rests on a shoulder screwed into the inner wall of the inner threaded tube and is held in place by a screw ring screwed onto the inner threaded tube. The driving pin is connected to the cam ring through a radial slot in the inner threaded tube. The cam ring has an axial curve on its camera-sided surface. A plunger is attached to the axial curve via a roller and is pivoted about an axis perpendicular to the system's optical axis. The plunger is coupled to the setting lever of the rangefinder.

When the distance setting ring is rotated, the cam ring is shifted axially, but also rotated around the system's optical axis. Both movements combined translate the relatively large axial shift of the threaded tube into the small plunger movement that is required for the adjustment of the setting lever in the rangefinder. In this way, the pitch of the axial curve can be used to compensate, to a limited extent, for different adjustment paths and non-linearities depending on the focal length between the axial adjustment movement of the optical imaging system and the coupled movement of the setting lever for the rangefinder. In order to adjust the setting lever and the focusing elements, so-called cylindrical curve threads are known for lens assembly designs, in which three groove curves of a cam carrier are provided, which are symmetrically distributed on the circumference of a fixed sleeve and rise linearly in axial direction; and into which sliding transmission elements engage interacting with a linear guide mechanism, to produce a rotary movement on the distance adjustment ring into an axial shift. The maximum rotation angle available for focusing from infinity to the closeup range is limited by the 120° range between the groove curves or sliding transmission elements, but also by the fact that a transmission element from the distance adjustment ring must be arranged in this segment to engage the linear guide mechanism of the cam carrier.

In this way, the accuracy of the focusing adjustment is limited, since for a relatively large axial shift of the threaded tube of the focusing mechanism only a rotation angle range of less than 95° is available on the distance setting ring. This proves to be particularly disadvantageous with lenses with a long focal length, which require a large adjustment range for focusing, as well as with lenses with a high aperture, since the depth of field on the image side is reduced, and in this way focusing inaccuracies set by the operator can no longer be compensated.

It has been shown that a rotation angle of 95° about meets the requirements for the focusing accuracy of a lens with a focal length of 50 mm in a range from 0.7 m to infinity. However, modern lens designs allow focusing on object distances of less than 0.7 m, e.g., up to 0.45 m. However, these settings would require a rotation angle of approximately 175°.

However, the arrangement of the groove curves symmetrically distributed around the circumference in an axial plane has proven to be effective for known cam carriers, as this avoids tilting moments and instabilities. In this way, the guideways or groove curves have the same axial pitch. The rotation angle of the distance setting ring is also limited by the beginning and end of the groove curves. Small axial shifts can be realized with a small axial pitch at a maximum rotation angle of 95°. In this way, there is just enough cylinder jacket material between the end of one groove curve and the beginning of the adjacent groove curve to ensure the mechanical stability of the cam carrier.

If larger rotation angles are to be realized in known 120° arrangements, this is only possible if the axial pitch of the guideways is chosen to be large enough that the beginning and end of adjacent groove curves have a sufficient axial offset. The minimum widths of the groove curves required for reliable mechanical movement do not allow for small axial shifts, such as those specified at 4.5 mm for the rangefinder setting lever.

A cylindrical mounting with a cam carrier and axially offset curve tracks is known from EP 2 693 247 A1, whereby the cam carrier enables a large rotation angle. The axially offset curved tracks require a lot of space and a large cylinder surface area. A small axial adjustment range is not feasible. In addition, the cylinder material is mechanically weakened due to the multiple, closely spaced openings for the curve tracks and is unstable under load in axial direction.

Other cylindrical mountings for optical components with cam carriers and cylindrical curve threads are known, e.g., from US 2015/0205068 A1 and U.S. Pat. No. 3,951,522. The invention was based on the object of improving the disadvantages of lenses in connection with rangefinder cameras with regard to the implementation of the adjustment paths for the focusing elements to the adjustment path of a rangefinder; to increase the adjustment accuracy of the axial positioning of the focusing elements in lenses, in particular with large shifting paths of the latter; and at the same time to ensure the required focusing transmission accuracy of a coupling to the setting lever of a camera rangefinder and its predetermined adjustment path. A further object of the invention was to realize a focusing capability to object distances shorter than 0.7 m, namely from infinity to 0.4 m, in a lens with rotary axial conversion for actuating the setting lever of a camera rangefinder.

This object is achieved by a cylindrical mounting for adjustable optical and mechanical components with the features of claim 1; advantageous embodiments and further developments are the subject of the subclaims.

In a cylindrical mounting according to the invention, a sleeve is provided that is fixed relative to a mounting, and that has three sliding transmission elements distributed along its inner cylinder circumference for operative connection with three corresponding groove curves of a cam carrier, rotatably mounted into the sleeve. Each of the three sliding transmission elements is allocated exactly one groove curve. The sliding transmission elements have a shape adapted to the groove curves, in particular as plastic round sleeves. For easy installation, the sliding transmission elements have a cylindrical pin shape with two different outer diameters. The larger diameter is used for easy insertion into drilled blind holes, which are provided on the outer cylinder circumference of the sleeve as through holes with an inner edge to support the cylinder part with a larger diameter. The smaller diameter is guided through the through hole into the groove curve, adapted to the width of the groove curve, and advantageously designed as a hollow cylinder. The diameters of the smaller cylinder part engaging in the groove curves can have a slight oversize compared to the respective groove width to compensate for any fluctuations in the groove width of the groove curves; but a precise fit is advantageous. A cylindrical ring that can be operated from the outside and that is fixed in an axial direction is rotatably mounted on the outer surface of the sleeve. At least one transmission element, e.g., in the form of a tab for engagement in a corresponding slot guide acting in an axial direction, is attached to this rotary ring. For this purpose, the slot guide is provided on the cam carrier parallel to the cylinder axis as a linear guide mechanism, advantageously on the outer circumference, so that the transmission element attached to the rotary ring can easily engage the slot guide and establish the operative connection. The rotation of the rotary ring then causes both a rotation and an axial shift of the cam carrier in the sleeve.

The same functionality is of course also guaranteed if the fixed sleeve is designed as a cam carrier with groove curves formed on its inner cylinder circumference, and if an axially movable mounted cylindrical sleeve in the cam carrier has the sliding transmission elements on its outer circumference for operative connection with the corresponding groove curves of the cam carrier. In this case, the linear guide mechanism must be installed inside the cylindrical sleeve with the sliding transmission elements/sliding sleeves, while the rotary ring is axially fixed onto the fixed cam carrier. This embodiment is the subject of the independent claim 15; advantageous embodiments emerge from the subclaims.

According to the invention, the angle between the radius of the first and second of the three sliding transmission elements is smaller than their respective angle to the third sliding transmission element. In this way, a rotation angle of 120°, which is otherwise usual or only possible on the rotary ring, is increased, and an inventive embodiment of the curve tracks or the groove curves is made possible. The basic idea of the invention is to create space in the cylindrical mounting for an increased rotation angle of the rotary ring in order to increase the axial adjustment accuracy of optical and mechanical components movable mounted in the mounting as well as to enable the rotational axial conversion of a small axial stroke of the cam carrier caused by the rotation of the rotary ring and the slot-shaped linear guide mechanism.

It is particularly advantageous if two of the three sliding transmission elements are arranged at a narrow radius angle of less than 90° to each other. To avoid mechanical instabilities and tilting moments, the third sliding transmission element is arranged at an angular distance on the circumference diametrically opposite the first and second. Surprisingly, it has been shown that this special arrangement of the sliding transmission elements on the circumference according to the invention does not cause any instabilities and tilting moments; and in this way a rotation angle of the rotary ring of greater than 100°, up to a maximum of 185°, can be realized. Groove curves can then be inserted into the cam carrier that have a small axial pitch but at the same time have a developed length greater than one-third of the circumference of the cam carrier.

Further advantageously, the first and the third sliding transmission element are arranged in one plane in axial direction, and the diameter of the second sliding transmission element is smaller than that of the adjacently arranged first sliding transmission element. In this way, while all sliding sleeves are guided undisturbed in their allocated groove curves, an overlap of the two groove curves of different width for the first and second sliding sleeves is possible.

In a further embodiment of the invention, the second sliding transmission element with a smaller diameter is arranged offset in axial direction to the plane of the first and third sliding transmission elements. In this case, the groove curve allocated to the second sliding transmission element can have an axial offset, preferably in the direction of the pitch of the other two groove curves. In this way, it is possible to at least partially overlap the narrower groove curve of the second sliding transmission element on the wider groove curve of the first sliding transmission element in order to keep the installation space that is required for the desired large rotation angle and any additional linear guide mechanisms required on the cam carrier free.

In order to ensure the safest, most independent and undisturbed guidance of the sliding sleeves of the first and second sliding transmission elements in the two partially overlapping groove curves, the radius distance of the first sliding transmission element to the cylinder axis is particularly advantageously greater than the radius distance of the second. It is essential to the invention that the radius distances of the two sliding transmission elements, which are arranged close to each other in a narrow angular range and differ in the diameter of the sliding sleeves, differ. Preferably, the radius distance of the sliding transmission element with a smaller diameter sleeve is always smaller than the radius distance of the sliding transmission element with a larger diameter sleeve. To make optimal use of the limited space available for the groove curves on the cylinder jacket, the third sliding element, which is arranged opposite the other two on the circumference, has a small diameter, e.g., corresponding to the smaller of the first or second sleeve. The space requirement for the width of the groove curve of the third sliding transmission element is thereby reduced, so that there is no overlap with the partially overlapping groove curves of the first and second sliding transmission elements. In this way, it is particularly advantageous for one end of the groove curve of the third sliding transmission element on the cam carrier to be axially offset up to one beginning of the groove curve of the second sliding transmission element, and to extend further on the circumference than one beginning of the groove curve of the first sliding transmission element.

In a further embodiment of the invention, the groove curves allocated to the sliding transmission elements are introduced into the outer surface of the cam carrier and are designed as a so-called cylindrical curve thread. The radius distance of the groove bottom of the groove curves is slidably adapted to the radius distance of the respective sliding transmission element. As already explained, the sliding transmission elements inserted into the sleeve have a cylindrical pin shape with two different sized outer diameters, whereby the larger diameter serves for easy and centered insertion into the drilled blind holes of the sleeve. In the radial direction, the penetration depth of the smaller diameter of the sliding elements into the groove curves can advantageously be used to center the cam carrier. In this way, the cam carrier is further guided in addition to the axially movable plain bearing of the cam carrier in the fixed sleeve, which effectively prevents any possible wobbling of the cam carrier axis around the axis of the socket or the sleeve. It is essential to the function of the invention that the groove curves at least partially have a groove bottom or at least a groove bottom edge and do not consist of open curves that penetrate the cylinder jacket of the cam carrier and thereby form a slot.

Particularly advantageously, the groove curves have an axial pitch on the outer circumference, which is adapted to a predetermined or desired axial stroke of the cam carrier. Due to the aforementioned special design according to the invention, groove curves may run linearly or non-linearly.

Further advantageously, the groove curves of different depths allocated to the first and second sliding transmission elements overlap at least partially. The thinner groove curve is inserted deeper into the cam carrier and the wider one is flatter.

In a further embodiment of the invention, the groove curves have a first segment with a pitch, which causes an axial stroke and as the groove curve continues, merges into a second segment without a pitch on the circumference of the cam carrier. Despite an angle adjustment on the rotary ring, this segment does not cause any axial stroke. Advantageously, the segment with pitch generated by the axial stroke of the cam carrier is adapted to the maximum adjustment range of the setting lever in the rangefinder of the camera and is 4.5 mm. In accordance with the required compatibility of a lens with a rangefinder camera mentioned in the introduction to the description, the axial stroke caused by the pitch corresponds to the maximum distance setting range of 0.7 m to infinity in the rangefinder of the camera. At the transition point from the segment with a pitch to that without a pitch, a haptic indicator can advantageously be provided to show the camera user that the close-up limit of focusing via the rangefinder has been reached. The haptic indicator can be formed by a spring-loaded locking pin that runs over a noticeable ramp at the transition point from the segment with a pitch to the segment without a pitch. In this way, it is possible to indicate to a user that further focusing of the focusing element is no longer possible with the optical rangefinder integrated into the camera but is only possible via alternative means. For example, digital cameras can use an electronic viewfinder (EVF), which must then be used to achieve close-range focusing between 0.7 m and e.g. 0.45 m. Advantageously, the rotation angle of the segment without a pitch is then used for extended near-field focusing of less than 0.7 m. In this case, the curve segment without a pitch advantageously corresponds to a close-focusing range of 0.7 m to 0.4 m. Lenses with an optically possible maximum focusing range of 0.4 m or smaller to infinity were previously only adjustable in the range 0.7 m to infinity due to the compatibility limitations of the rangefinder camera. With lenses equipped with the invention, focusing on an extended close-up range is also possible. For use of the cylindrical mounting according to the invention on a camera, preferably a rangefinder camera, a bayonet connection is provided on the fixed sleeve of the lens for snap-locking to the camera system. For a rotation angle-oriented locking to a camera lens mounting, the lens has an optical marker on its outside, that is arranged on the circumference, seen in the direction of locking, at a distance from a locking recess in the front surface of the bayonet connection. Advantageously, the first and the second sliding transmission element are provided at an angular distance spaced from the locking recess such that, viewed in axial direction of the camera, they are arranged advantageously on the left and right after being locked into the segment of the setting lever of the rangefinder.

Particularly advantageous, the first and the second sliding transmission elements are arranged at an angle of 28° to each other or, viewed on the bayonet, both are arranged at an angle range of 45° to 135° counterclockwise from the locking recess. In this way, despite the asymmetrical distribution of the three sliding transmission elements on the cylinder circumference of the cam carrier, a stable connection to the adjusting lever of the camera's rangefinder and a play-free transmission of the axial movement of the cam carrier to the setting lever is ensured.

In a further embodiment of the invention, a worm thread sleeve with a slot-shaped linear guide mechanism is arranged on the fixed sleeve for the axial shift of another optical component. The worm thread sleeve is in operative connection with the rotary ring, so that a rotation is converted into an axial shifting movement of the other optical component. The operative connection to the worm thread sleeve can advantageously be achieved by an internal worm thread formed on the inside of the rotary ring, while a cylindrical inner sleeve has a corresponding external worm thread that meshes with the internal worm thread of the rotary ring. To prevent rotation, the cylindrical inner sleeve has a slot-shaped linear guide mechanism into which a transmission element in the form of a tab connected to the fixed sleeve of the cylindrical mounting engages. In this way, the rotation of the rotary ring is converted into a linear movement of the cylindrical inner sleeve. The cylindrical inner sleeve can advantageously be used to axially shift a focusing element or so-called floating element of a lens. It is advantageous for the optical calculation of the lens that the pitch of the worm thread can be adjusted to a desired focusing accuracy depending on the large rotation angle on the rotary ring made available by the invention, and independently of the axial shift specified for moving the setting lever of a rangefinder.

Embodiments of the cylindrical mounting according to the invention are shown schematically in the drawing and are described in more detail below with reference to the figures.

Hereby show:

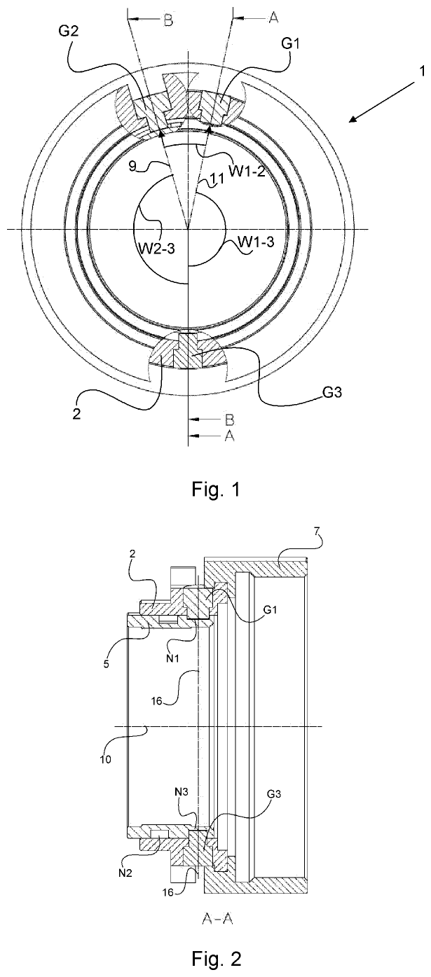

FIG. 1 a cylindrical mounting seen in axial direction with partial sectional view parts (section A-A and section B-B)

FIG. 2 a sectional view along the cutaway view A-A from FIG. 1

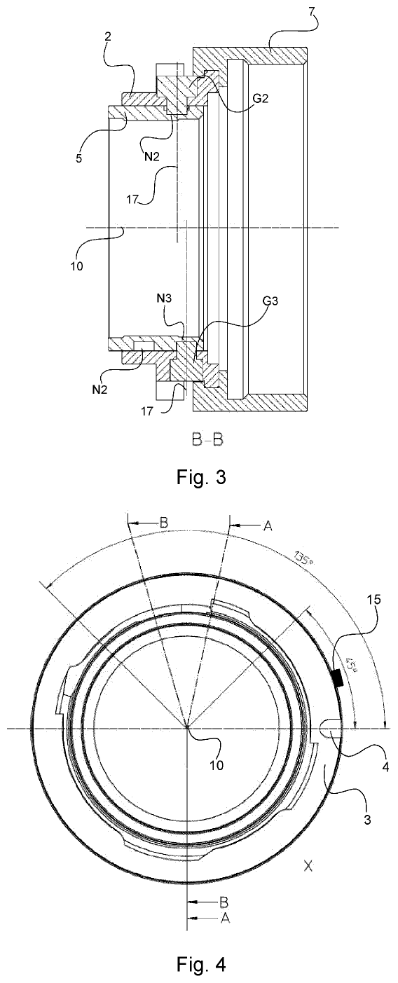

FIG. 3 a sectional view along the offset cutaway view B-B from FIG. 1

FIG. 4 a top view X of a cylindrical socket with bayonet connection (section A-A and section BB as in FIG. 1)

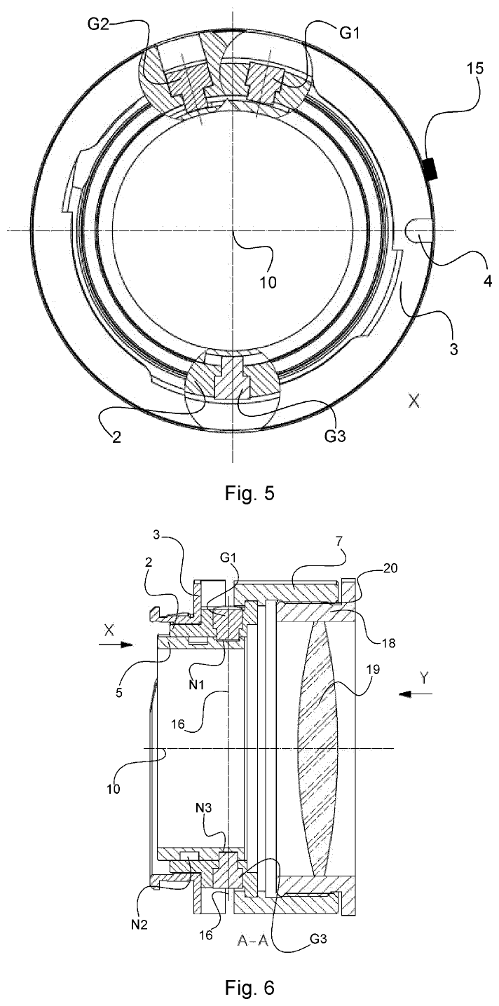

FIG. 5 a top view X as in FIG. 4 with cutaway views along A-A and B-B and locking recess

FIG. 6 a sectional view along the cutaway view A-A as in FIG. 4

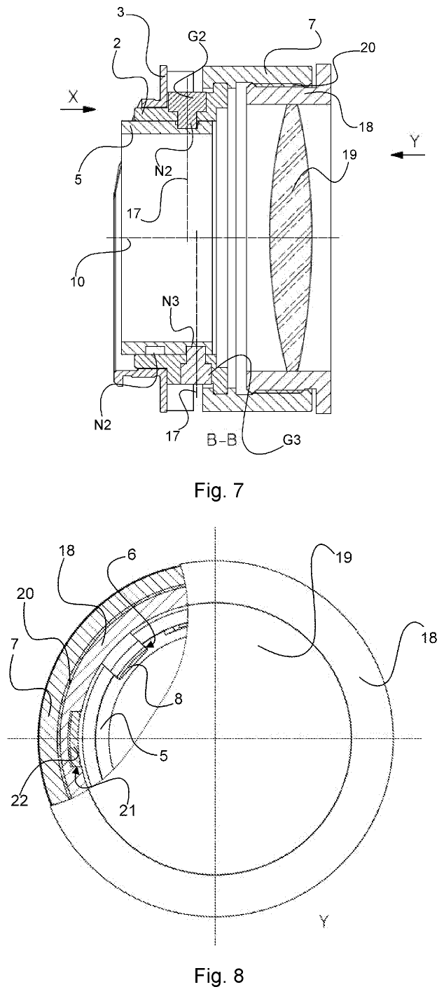

FIG. 7 a sectional view along the offset cutaway view B-B as in FIG. 4

FIG. 8 a top view Y (as in FIGS. 6 and 7) with cutaway view

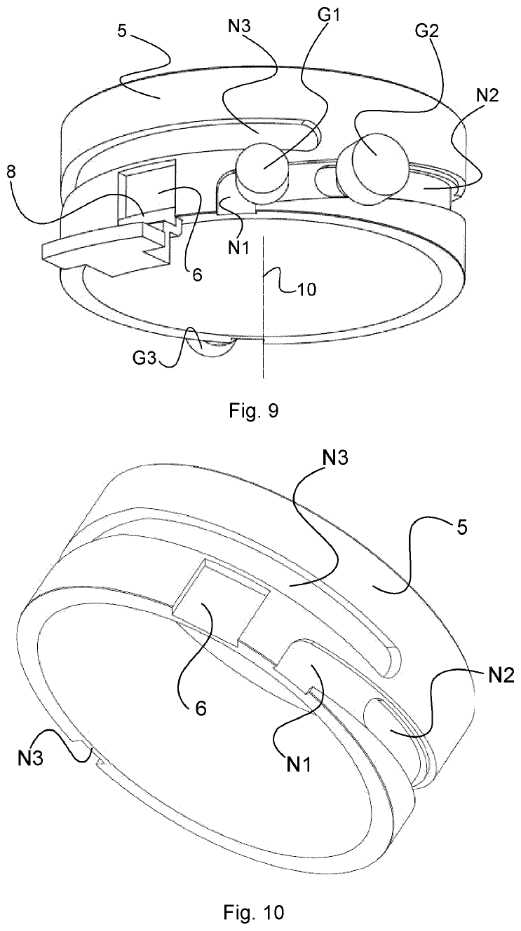

FIG. 9 a cam carrier perspective view with transmission elements

FIG. 10 a cam carrier perspective view without transmission elements

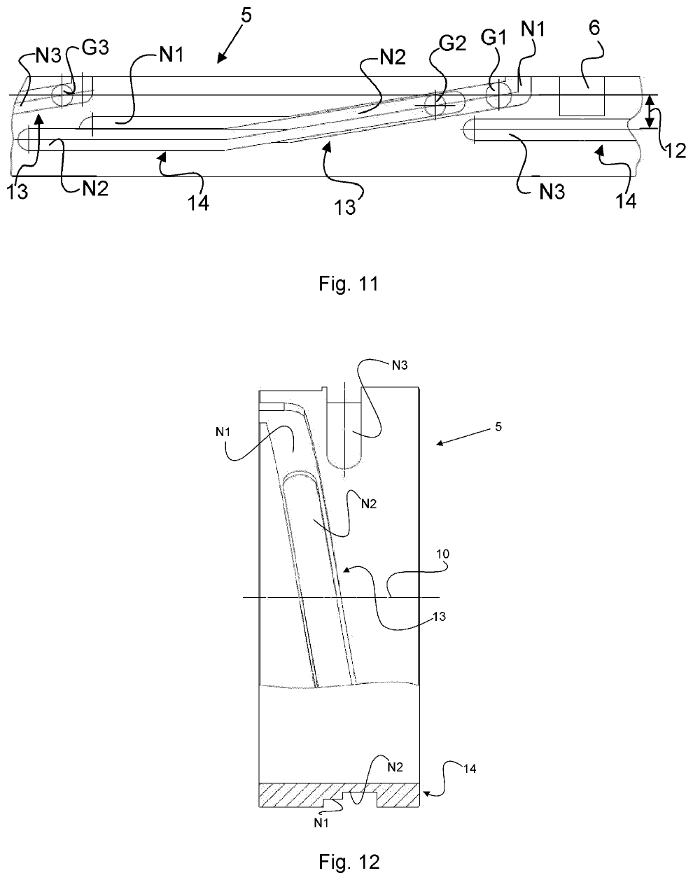

FIG. 11 wind-up of a cam carrier

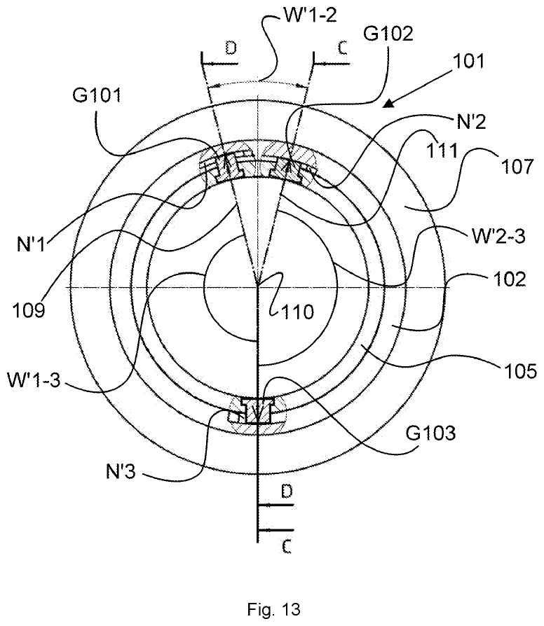

FIG. 12 side view of the cam carrier with cutaway view

FIG. 1 shows a cylindrical mounting 1 for optical or mechanical components that can be adjusted in the direction of an optical or cylinder axis 10. The partial top sectional views along the section lines A-A and B-B show sectional views of the sliding transmission elements G1, G2, and G3, which are inserted into a fixed sleeve 2. The sliding transmission elements G1, G2, and G3 have a cylindrical pin shape with two different outer diameters. The larger diameter is inserted into a drilled blind hole, which is provided on the outer cylinder circumference of the sleeve 2. The drilled blind holes are provided as through holes in the sleeve 2 and are designed with an inner shoulder to support the respective cylinder part with a larger diameter. The sliding transmission elements G1 and G2 are arranged relative to their radii on the circumference of the sleeve 2 at an angular distance of less than 90° with an angular distance W1-2 from each other. The angular distance W1-2 between the sliding transmission elements G1 and G2 is therefore smaller than the angular distance W1-3 between the sliding transmission elements G1 and G3, and also smaller than the angular distance W2-3 between the sliding transmission elements G2 and G3. In the example shown in FIG. 1, the angle W1-2 is 28°, the angle W1-3 is 168°, and the angle W2-3 is 164°. The axial distance to the cylinder axis 10 of the cylinder parts of the sliding elements G2 and G1 with smaller diameter guided through the through hole is referred to as radius distance 9 and 11. The radius distance 11 of the first sliding transmission element G1 is greater than the radius distance 9 of the second sliding transmission element G2. Additionally, the outer diameter of the smaller diameter cylinder part of the sliding element G1 guided through the through hole is also larger than the outer diameter of the smaller diameter cylinder part of the sliding element G2 guided through the through hole.

FIG. 2 shows a sectional view along A-A from FIG. 1. A cam carrier 5 is mounted inside the sleeve 2, so that it can be rotated and axially shifted along a cylinder axis 10. The cam carrier has groove curves N1, N2, and N3 incorporated into its cylinder outer surface. The sliding transmission element G1 engaging the groove curve N1 and the sliding transmission element G3 engaging the groove curve N3 are arranged in axial direction in a plane, marked by the dashed line 16. A rotary ring 7 is shown schematically mounted on the sleeve 2, so that it can rotate and is not axially movable. For the axial shift of the cam carrier 5, a transmission element (not shown in FIG. 2) is attached to the rotary ring 7 and engages in a linear guide mechanism (also not shown). The transmission element and the linear guide mechanism are described in more detail below with reference to FIG. 9.

FIG. 3 shows a sectional view along the section line B-B shown in FIG. 1, which has an axial offset at the cylinder axis 10. The sliding transmission element G2 is arranged at an axial distance from the sliding transmission element G3. For clarification, the dashed line 17 on the cylinder axis 10 has a lateral offset in axial direction. The dashed line through the sliding transmission element G3 corresponds to the dashed line 16 of FIG. 2 up to the cylinder axis 10.

FIG. 4 shows a cylindrical mounting 1 with a bayonet connection 3 to lock the mounting 1 to a camera system (not shown) in a top view X. The bayonet connection 3 has a locking recess 4 in its support surface for locking into place. Viewed counterclockwise from the locking recess 4, an angle range between 45° and 135° is provided. The section planes A-A and B-B in FIG. 4 correspond to those in FIG. 1.

This is illustrated by partial sectional views in FIG. 5, in which the sliding transmission elements G1, G2, and G3 are shown in cross section and their angular position with respect to the locking recess 4. An optical marking 15 is provided on the outside of the cylindrical frame 1 in a counterclockwise direction between the locking recess 4 and the position of the sliding transmission element G1.

FIG. 6 shows a sectional view along line A-A from FIG. 4. In rotary ring 7, an optical mounting 18 with a lens 19 is mounted, so that it is axially movable via a worm thread 20. Comparable to FIG. 2, the sliding elements G1 and G3 are arranged in a plane, shown by the dashed line 16.

FIG. 7 shows a cross-section along the offset cutaway view B-B from FIG. 4. Comparable to FIG. 2, the sliding transmission elements G2 and G3 are arranged axially offset along the dashed line 17.

FIG. 8 shows a top view Y corresponding to the representations in FIG. 6 and FIG. 7 of the lens 19 and the mounting part 18 as a partially sectioned view. The partially sectioned view shows the guiding element 8 fastened to the rotary ring 7 in the linear guide mechanism 6 of the cam carrier 5. The mounting part 18 shown in cutaway view has an axially extending groove 21 on its inner cylinder surface, into which a transmission element 22 fastened to the sleeve 2 engages to axially shift the mounting 18.

FIG. 9 shows a perspective view of a cam carrier 5 with sliding transmission elements G1 and G2 arranged next to one another and shown without a sleeve 2, and which engage the beginning of the groove curves N1 and N2 allocated to them. The end of the groove curve N3 is shown axially offset to the sliding transmission element G1. The sliding transmission element G3 is shown schematically and partially hidden by the cam carrier 5 and is located on the outside of the cam carrier 5 at the beginning of the groove curve N3 (not visible here).

To clarify the positions of the groove curves N1, N2, and N3 as well as of the slot-shaped linear guide mechanism 6 on the circumference, the cam carrier 5 from FIG. 9 is shown in FIG. 10 without the sliding transmission element G1, G2, and G3.

FIG. 11 shows the outside of the cam carrier in an unfurled view, which further illustrates the design and positioning of the groove curves N1, N2, and N3. The sliding transmission elements G1, G2, and G3 are each shown at a position that represents the beginning segment of the respective corresponding groove curves N1, N2, and N3. An axial stroke 12 of the cam carrier 5 is formed by the segment of the groove curves N1, N2, and N3, with the axial pitch 13 starting from the beginning, followed by the segment without pitch 14 and without axial stroke up to the end of the groove curves. The sliding transmission element G1 is arranged in an axial plane that is the same as for the sliding transmission element G3. In FIG. 11, sliding transmission elements G1 and G3 are therefore arranged on the same dashed line running parallel to the edge of the cam carrier 5. The beginning segment of the associated groove curves N1 and N3 is open in axial direction towards the edge of the cam carrier 5. Sliding transmission element G1 has a larger diameter than sliding transmission element G3. Sliding transmission element G1 also has a larger diameter compared to sliding transmission element G2, so that the width of the associated groove curve N1 is also larger than the width of the groove curve N2 of the sliding transmission element G2. The groove curve N1 runs in its beginning segment up to the beginning segment of the groove curve N2 without overlapping. To overlap the groove curves N1 and N2 in the segment with axial pitch 13, the thinner groove curve N2 is inserted deeper inside the cam carrier 5 and the wider groove curve N1 is shallower. The groove curve depth of the wider and less deep groove curve N1 corresponds to the larger radius distance 11 of the first sliding transmission element G1 shown and described in FIG. 1. The groove curve depth of the narrower and deeper groove curve N2 corresponds to the smaller radius distance 9 of the sliding transmission element G2 shown and described in FIG. 1. The axial offset between sliding transmission element G1 and G2 corresponds to the radius of the sliding transmission element G2 in FIG. 11. In this way, there is a narrow support edge for the wider groove curve N1 in the pitched segment 13 to the left and right of the deeper groove curve N2. In conjunction with the groove curve N2, which is set deeper in the groove curve N1 but which is also narrower, both can overlap without interference, while sliding transmission element G1 is safely guided in the groove curve N1, and the narrower sliding transmission element G2 is safely guided in the groove curve N2. Advantageously, after the transition from the segment with axial pitch 13 to the segment without pitch 14 for the wider groove curve N1, a lateral support edge as wide as the radius of the sliding transmission element G2 remains for radial guidance and additional coaxial alignment of the cam carrier 5 in the sleeve 2 or in the mounting 1. In the segment without axial pitch 14, the cam carrier no longer shifts axially but only rotates on the spot. The segment at the end of groove curve N2 is arranged axially offset from the beginning of groove curve N3 by the amount of the axial stroke 12, without overlapping with groove curve N1.

FIG. 12 shows a cam carrier 5 in a side view of the cylinder outer surface. In the segment shown above the cylinder axis 10 with pitch 13, the initial segment of the wide groove curve N1 is shown next to the end of the narrow groove curve N3. Without overlapping with the groove curve N2 in the cam carrier 5 in relation to the also narrower groove curve N2, the beginning segment of groove curve N1 runs less deep but wider than the adjoining and overlapped groove curve N2. In the lower segment of FIG. 12, a partial sectional view is shown as a sectional view in the groove curves segments N1 and N2 without pitch 14. The sliding element G2 (not shown) penetrates the groove curve N2 all the way down to the groove bottom of groove curve N2, while the groove bottom for sliding element G1, which has a wider diameter, is formed from a groove curve edge N1, which corresponds in width to half of groove curve N2. An alternative cylindrical mounting, making use of the same inventive basic idea is the subject of claim 15, whereby the same object is achieved with the features of this claim and advantageous embodiments and further developments, are the subject of the subclaims referring to claim 15.

In the cylindrical mounting 101, the groove curves N′1, N′2, N′3 allocated to the sliding transmission elements G101, G102, G103 in the cam carrier 102 are advantageously designed as cylindrical curve threads and introduced into the inner surface of the cam carrier 102. The axial distance from the groove bottom to the cylinder axis 110 is referred to as radius distance 109, 111 and is adapted to the outward-facing axial distance/radius distance of the respective sliding transmission element G101, G102.

In an advantageous embodiment of the cylindrical mounting 101, the groove curves N′1, N′2, N′3 have a pitch in axial direction adapted to a predetermined axial stroke of the sleeve 105, whereby the groove curves N′1, N′2, N′3 can be linear or non-linear.

In a further designed cylindrical mounting 101 according to the invention, the groove curves N′1, N′2 of different depths or different radius distances 109, 111 allocated to the first G101 and second G102 sliding transmission elements overlap at least partially.

Furthermore, the groove curves in the cylindrical mounting 101 can advantageously have a first segment with a pitch 13, which causes an axial stroke 12 of the sleeve 105, and a second segment without a pitch 14 which does not cause an axial stroke 12. In a further advantageous embodiment, a bayonet connection with a locking recess for locking to a camera system (not further described) is provided on the fixed cam carrier 102, and the first and second sliding transmission elements G101, G102 are arranged at an angular distance spaced from the locking recess.

Particularly advantageous is the arrangement of the first and second sliding transmission elements G101, G102 at a distance from the locking recess 4 to the bayonet connection 3 in a counterclockwise direction at an angular distance of 45° to 135°.

In a cylindrical mounting 101 designed according to the invention, a worm thread sleeve 18 with a slot-shaped linear guide mechanism for the axial shift of a further optical component 19 is arranged on the fixed cam carrier 102 and is in operative connection with the rotary ring 107.

Advantageously, the axial shifting path 12 of the worm thread sleeve 18 can be greater or smaller than the axial shifting path 12 of the sleeve 105, whereby a further transmission element 22 connected to the fixed cam carrier 102 is provided with engagement in the slot-shaped linear guide mechanism 21 of the worm thread sleeve 18 to prevent rotation. In this way, a reduction or translation between the axially movable sleeve 105 and the worm thread sleeve 18 can be realized with e.g., a focusing element of an objective.

Particularly advantageously, the rotation angle of the rotary ring 107 is between 100° and a maximum of 185° to ensure a particularly sensitive adjustment of the focus via the focusing element.

Embodiments of the cylindrical mounting according to claim 15 of the invention are shown schematically in the drawing with reference to equivalent alternative features and are described in more detail with reference to FIGS. 13 to 19.

FIG. 13 shows an alternative cylindrical mounting 101 for optical or mechanical components that can be adjusted in the direction of an optical or cylinder axis 110. The top view of partial sectional view parts along the section lines C-C and D-D show sectional views of the sliding transmission elements G101, G102, and G103, which are inserted into a fixed cam carrier 102. The sliding transmission elements G101, G102, and G103 have a cylindrical pin shape with two different outer diameters. The larger diameter is inserted into a drilled blind hole, which is provided on the inner cylinder circumference of the cam carrier 102. The drilled blind holes are provided as through holes in the cam carrier 102 and are designed with an inner edge to support the respective cylinder part with a larger diameter. The sliding transmission elements G101 and G102 are arranged relative to their radii on the outer circumference of the cam carrier 102 at an angular distance of less than 90° and with an angular distance W1-2 from each other. The angle between the radii of the sliding transmission elements G101 and G102 or the angular distance W′1-2 between the sliding transmission elements G101 and G102 is therefore smaller than the angular distance W′1-3 between the sliding transmission elements G101 and G103, and also smaller than the angular distance W2-3 between the sliding transmission elements G102 and G103. In this way, the distance on the circumference of the sleeve 105 between the first G101 and the second G102 of the three sliding transmission elements is smaller than their respective distance on the circumference to the third sliding transmission element G103. The design according to the invention, which deviates from the usual 120° symmetrical arrangements, can also be determined by the angle between the radius vectors or angles between the radii of the sliding transmission elements. In the example shown in FIG. 13, the angle W1-2 is 30°, the angle W1-3 is 165°, and the angle W2-3 is 165°. The axial distance to cylinder axis 110 of the cylinder parts of the sliding elements G101 and G102 with smaller diameter guided through the through holes is referred to as radius distance 109 (for G101) and 111 (for G102). The radius distance 111 of the second sliding transmission element G102 is smaller than the radius distance 109 of the first sliding transmission element G101. The outer diameter of the smaller diameter cylinder part of the sliding element G102 guided through the through hole is larger than the outer diameter of the smaller diameter cylinder part of the sliding element G101 guided through the through hole.

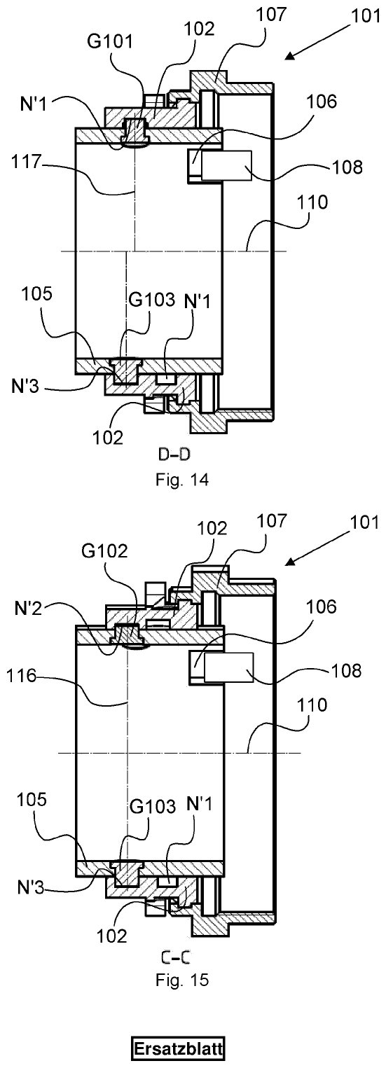

FIG. 14 shows a sectional view along the section line D-D shown in FIG. 13, which has an axial offset at the cylinder axis 110. The sliding transmission element G101 is arranged at an axial distance from the sliding transmission element G103. For clarification, the dashed line 117 on the cylinder axis 110 has a lateral offset in axial direction. The dashed line through the sliding transmission element G103, up to the cylinder axis 10 corresponds to the dashed line 116 in FIG. 15.

FIG. 15 shows a sectional view along C-C from FIG. 13. Inside the cam carrier 102, a sleeve 105 is mounted, so that it can be rotated and axially shifted along a cylinder axis 110. The cam carrier 102 has groove curves N′1, N′2, and N′3 incorporated in its cylinder inner surface. The sliding transmission element G101 engaging in the groove curve N′1 and the sliding transmission element G103 engaging in the groove curve N′3 are arranged in axial direction in a plane, marked by the dashed line 116. A rotary ring 107 is shown schematically mounted on the cam carrier 102, so that it can rotate and is not axially movable. For the axial shift of the sleeve 105, a transmission element 108 is attached to the rotary ring 107 and engages in a slot-shaped linear guide mechanism 106.

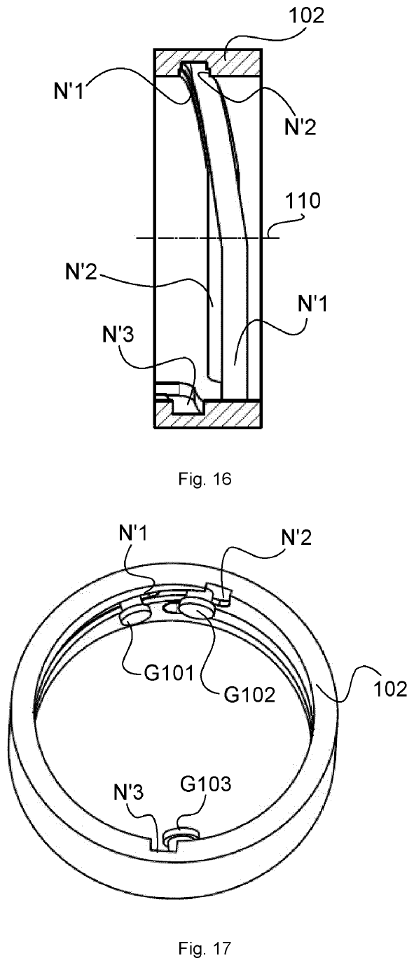

FIG. 16 shows a sectional view of the inside of the cam carrier 102 that further illustrates the design and positioning of the groove curves N′1, N′2, and N′3 relative to one another. Above the cylinder axis 110, overlapping, axially linearly rising segments of the groove curves N′1 and N′2 are shown, which cause an axial stroke of the sleeve 105 in the event of a rotation of the sleeve 105 (not shown in FIG. 16). Below the cylinder axis 110, the groove curves N′1 and N′2 run with an axial offset that corresponds to the offset between the dashed line 117 in FIG. 14 and the dashed line 116 in FIG. 15. In this segment, however, the groove curves N′1 and N′2 run parallel to each other and no longer increase linearly axially. If the sliding transmission elements G101 and G102 of the sleeve 105 (not shown) engage this segment, no axial shift of the sleeve 105 along the cylinder axis 110 within the cam carrier 102 occurs, despite the rotation of the sleeve 105.

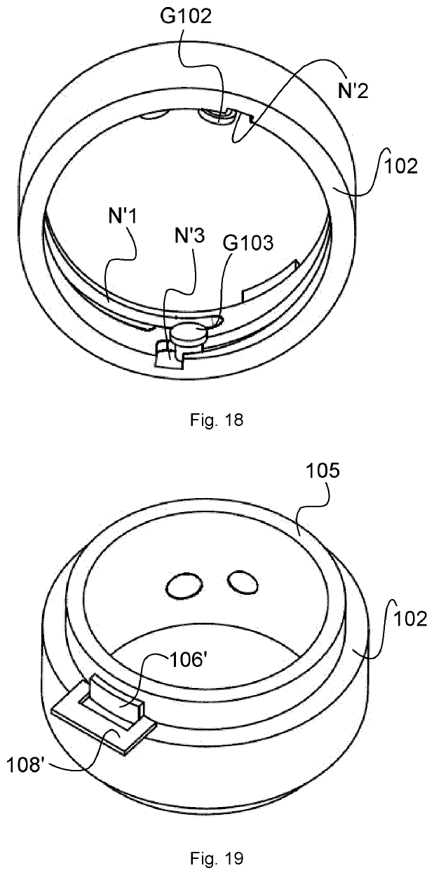

The perspective views in FIGS. 17 and 18 illustrate the geometric positioning of the groove curves N′1, N′2, and N′3 on the cam carrier inner circumference 102. The sliding transmission elements G101, G102, and G103 that are engaging in the groove curves are shown schematically and without sleeve 105.

FIG. 19 shows an alternative linear guide mechanism 106′ that is designed as a raised formation on the sleeve 105, which is running parallel to the cylinder axis 110. The transmission element 108′ attached to the rotary ring 107 (not shown) encompasses the linear guide mechanism 106′. In this way, a rotary movement on the rotary ring 107 can be transmitted to the sleeve 105 via the transmission element 108′ and, due to the operative connection between the groove curves of the cam carrier 102 and the sliding transmission elements of the sleeve 105, can be converted into an axial shift of the sleeve 105.

### LIST OF REFERENCE SIGNS

1, 101 Cylindrical Mounting
2, 105 Stationary Sleeve
3 Bayonet Connection
4 Locking Recess
5, 102 Cam carrier
6, 106 Slot-Shaped Linear Guide Mechanism
106′ Linear Guide Mechanism, outside
7, 107 Rotary Ring
8, 108 Guiding Element, rotation
9 Radius Distance Sliding Transmission Element G2
109 Radius Distance Sliding Transmission Element G101
10, 110 Cylinder Axis
11 Radius Distance Sliding Transmission Element G1
111 Radius Distance Sliding Transmission Element G102
12 Axial Stroke
13 Groove Curve Segment with Axial Pitch
14 Groove Curve Segment without Axial Pitch
15 Optical Marker
16 Dashed Line Plane G1 G3
116 Dashed Line Plane G102 G103
17 Dashed Line Axial Offset G2 G3
117 Dashed Line Axial Offset G101 G103
18 Mounting with Worm Threat, Worm Threat Sleeve
19 Lens
20 Worm Threat
21 Axially Extending Groove
22 Transmission Element, fixed
G1, G2, G3 Sliding Transmission Element
G101, G102, G103 Sliding Transmission Element, alternative
N1, N2, N3 Groove Curves
N′1, N′2, N′3 Groove Curves, alternative
W1-2 Angle Between Sliding Transmission Elements G1 and G2
W1-3 Angle Between Sliding Transmission Elements G1 and G3
W2-3 Angle Between Sliding Transmission Elements G2 and G3
W′1-2 Angle Between Sliding Transmission Elements G101 and G102
W1-3 Angle Between Sliding Transmission Elements G102 and G103
W′2-3 Angle Between Sliding Transmission Elements G102 and G103

1. Cylindrical mounting for adjustable optical and mechanical components, comprising a sleeve which is stationary relative to a mounting and comprises three sliding transmission elements distributed on the sleeve inner cylinder circumference for operative connection with corresponding grooves of a cam carrier which is supported in the sleeve in a rotationally and axially movable manner and which has a slot-shaped linear guide mechanism; and a rotary ring which is stationary in axial direction, is supported on the outer surface of the sleeve and can be actuated from outside, which rotary ring has at least one transmission guiding element for engagement in the slot-shaped linear guide mechanism of the cam carrier, whereby the angle between the radius of a first and a second of three sliding transmission elements is smaller than their respective angles with respect to the third sliding transmission element.

2. Cylindrical mounting according to claim 1, wherein the angle between the radius of the first and the second sliding transmission elements is smaller than 90°.

3. Cylindrical mounting according to claim 2, wherein the first and the third sliding transmission elements are arranged in one and the same plane in axial direction, and a diameter of the second sliding transmission element is smaller than a diameter of the first sliding transmission element.

4. Cylindrical mounting according to claim 3, wherein the second sliding transmission element with a smaller diameter is axially spaced by a distance in axial direction from the plane where the first and third sliding transmission element are located.

5. Cylindrical mounting according to claim 3, wherein the radial distance of the second sliding transmission element from the cylinder axis, which second sliding transmission element is smaller in diameter than the first sliding transmission element, is shorter than the radial distance of the first sliding transmission element from the cylinder axis.

6. Cylindrical mounting according to claim 5, wherein the groove curves allocated to the sliding transmission elements in the cam carrier are designed as cylindrical curve threads and are introduced into the outer surface of the cam carrier, wherein the radial distance of the groove bottom is adapted to the radial distance of the respective sliding transmission element.

7. Cylindrical mounting according to claim 6, wherein the groove curves have a pitch adapted in axial direction to a predetermined axial stroke of the cam carrier, wherein the groove curves are linear or non-linear.

8. Cylindrical mounting according to claim 7, wherein the groove curves of different depths allocated to the first and second sliding transmission elements overlap each other at least partially.

9. Cylindrical mounting according to claim 8, wherein the groove curves have a first segment with a pitch causing an axial stroke and a second segment without a pitch causing no axial stroke.

10. Cylindrical mounting according to claim 1, wherein a bayonet connection with a locking recess for locking attachment to a camera system is provided on the fixed sleeve, and the first and second sliding transmission elements are arranged in an angular distance spaced from the locking recess.

11. Cylindrical mounting according to claim 10, wherein the first and the second sliding transmission elements are arranged at a distance from the locking recess at an angular distance of 45° to 135°, viewed counterclockwise on the bayonet connection.

12. Cylindrical mounting according to claim 11, wherein a worm thread sleeve with a slot-shaped linear guide mechanism is arranged on the fixed sleeve for axially moving another optical component.

13. Cylindrical mounting according to claim 12, wherein the axial moving distance path of the worm thread sleeve is longer or shorter than the axial moving distance path of the cam carrier, wherein another transmission element connected to the fixed sleeve is provided with engagement in the slot-shaped linear guide mechanism of the worm thread sleeve to prevent rotation.

14. Cylindrical mounting according to claim 2, wherein the rotation angle of the rotary ring is between 100° and a maximum of 185°.

15. Cylindrical mounting for adjustable optical and mechanical components with a cam carrier fixed relative to a mounting and having three groove curves distributed on its inner cylinder circumference for an operative connection with the corresponding sliding transmission elements of a sleeve that is rotatably and axially movable mounted into the cam carrier and has a slot-shaped linear guide mechanism and a rotary ring, which is fixed in axial direction, mounted on the outer surface of the cam carrier and operable from the outside and has at least one transmission guiding element for engagement in the slot-shaped linear guide mechanism of the sleeve, wherein the angle between the radius of a first and a second of three sliding transmission elements is smaller than their respective angle to the third sliding transmission element, or that the distance on the circumference of the sleeve between the first and the second of the three sliding transmission elements is smaller than their respective distance on the circumference to the third sliding transmission element.

16. Cylindrical mounting according to claim 15, wherein the angle between the radius of the first and the second sliding transmission elements is smaller than 90°, or the distance on the circumference of the sleeve between the first and the second sliding transmission elements is smaller than 25% of the total circumference of the sleeve.

17. Cylindrical mounting according to claim 16, wherein the second and the third sliding transmission elements are arranged in one and the same plane in axial direction, and that the diameter of the first sliding transmission element is smaller than that of the second sliding transmission element.

18. Cylindrical mounting according to claim 17, wherein the first sliding transmission element with a smaller diameter is axially spaced apart by a distance in axial direction from the plane of the second and third sliding transmission elements.

19. Cylindrical mounting according to claim 17, wherein the radial distance from the cylinder axis of the first sliding transmission element, which is smaller in diameter than the second sliding transmission element, is longer than the radial distance of the second sliding transmission element from the cylinder axis.
